(19) United States
(12) Patent Application Publication
(10) Pub. No.: US 2011/0001098 A1
(43) Pub. Date: Jan. 6, 2011

(54) UTILITY JACK

(75) Inventor: Yeo (Joseph) B. Lee, Santa Clara, CA (US)

Correspondence Address: MAIER & MAIER, PLLC, 1000 DUKE STREET, ALEXANDRIA, VA, 22314, US

(73) Assignee: K&L Supply Co., Inc., Santa Clara, CA (US)

(21) Appl. No.: 12/495,929

(22) Filed: Jul. 1, 2009

(51) Int. Cl. B66F 3/08; B66B 5/28; B66F 7/28; B65G 47/90

(52) U.S. Cl. 254/126; 187/343; 187/216; 414/816; 187/269

(57) ABSTRACT

A utility lift may include a base frame, an upper plate and a plurality of support arms engaged with the base frame and the upper plate. The support arms may include first and second support arms adjustably engaged with the upper plate and third and fourth support arms adjustably engaged with the base frame. An exemplary embodiment may also include a power source connected to an engagement member, where the power source can be adapted to manipulate the engagement member and the engagement member can engage the plurality of support arms.

### RELATED APPLICATIONS

This application claims priority, under 35 U.S.C. §119(e), to U.S. Provisional Patent Application Ser. No. 61/129,371, filed Jun. 20, 2008, the disclosure of which is incorporated by reference herein in its entirety.

### BACKGROUND

Lifts and jacks, such as vehicle lifts, are commonly used to enable a user to work on heavy equipment, such as automobiles, motorcycles, all-terrain vehicles and/or other personal transportation equipment. Some known examples of jacks may be portable or coupled to a floor and generally apply force over a small area of an object in order to raise the object or a portion of the object. Such examples may not be practical for individual enthusiasts that desire to work on their own equipment that require specialized lifting capabilities.

Other known examples of jacks merely lift one end of the object and/or only partially lift the object off the ground. Such examples make working on the object very difficult since the user is generally forced to work close to the ground or on their back underneath the object. As a result, a user wishing to work on their personal transportation equipment at a comfortable standing level may be forced to purchase a larger jack than they need and/or dedicate a large portion of the property to house the jack.

### SUMMARY

According to at least one embodiment, a utility jack may include a base frame, an upper plate and a plurality of support arms engaged with the base frame and the upper plate. The support arms can include first and second support arms adjustably engaged with the upper plate and third and fourth support arms adjustably engaged with the base frame. An exemplary embodiment may also include an engagement member coupled to the plurality of support arms and the engagement member may manipulate the lateral movement of the plurality of support arms with respect to both the upper plate and the base frame.

In exemplary method of lifting a desired object, the method may include loading an object onto an upper plate supported by a base frame and two pairs of support arms, each pair of support arms connected at a joint. Next, a user can actuate an air control valve in fluid communication with an air cylinder and retract an engagement member connected to the air cylinder, toward the air cylinder. Then a user can raise the upper plate by forcing apart the two pairs of support arms with the engagement member.

In an exemplary method of elevating an object, the method may include loading an object onto an upper plate supported by a base frame and two pairs of support arms, a first pair and a second pair, each pair of support arms connected at a joint. Next, a user can actuate an engagement member coupled to both pairs of support arms and slide the first pair of support arms in a lateral direction along the upper plate. Then the user can slide the second pair of support arms in a lateral direction along the base frame and raise the upper plate by forcing terminating ends of the two pairs of support arms together.

### BRIEF DESCRIPTION OF THE FIGURES

Advantages of embodiments of the utility lift will be apparent from the following detailed description of the exemplary embodiments thereof, which description should be considered in conjunction with the accompanying drawings in which:

FIG. 1 is a perspective view of an exemplary embodiment of an elevated utility jack.

FIG. 2 is a perspective view of an exemplary embodiment of a compressed utility jack.

FIG. 3 is an exploded view of an exemplary embodiment of a utility jack.

FIG. 4a is an exploded view of a cushion attachment for a utility jack.

FIG. 4b is an isometric view of a cushion attachment coupled to a utility jack.

FIG. 5a is an exploded view of a three-wheeled vehicle support attachment for a utility jack.

FIG. 5b is an isometric view of a three-wheeled vehicle support attachment coupled to a utility jack.

FIG. 6a is an exploded view of a frame support adapter for a utility jack.

FIG. 6b is an isometric view of a frame support adapter coupled to a utility jack.

FIG. 7a is an isometric view of a support platform for a utility jack.

FIG. 7b is an isometric view of a support platform coupled to a utility jack.

### DETAILED DESCRIPTION

Aspects of the utility jack are disclosed in the following description and related drawings directed to specific embodiments of the utility jack. Alternate embodiments may be devised without departing from the spirit or the scope of the utility jack. Additionally, well-known elements of exemplary embodiments of the utility jack will not be described in detail or will be omitted so as not to obscure the relevant details of the utility jack. Further, to facilitate an understanding of the description a discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the utility jack”, “embodiment” or “utility jack” do not require that all embodiments of the utility jack include the discussed feature, advantage or mode of operation.

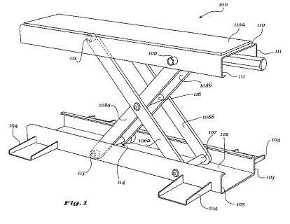

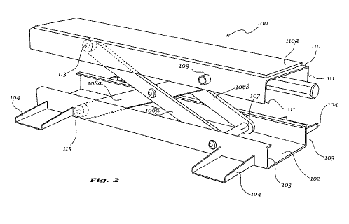

Referring to FIGS. 1-3, in an exemplary embodiment, utility jack 100 may include a base frame 102. Base frame 102 may be formed in a substantially rectangular shape or in any other desired shape. Base frame 102 may act as the foundation of utility jack 100 and may include support feet 104. Support feet 104 can extend from each terminal end of base frame 102 or at any other desired positions along the base frame 102. In an exemplary embodiment, base frame 102 may include two pairs of support feet 104 extending from opposite ends of base frame 102. In another exemplary embodiment, base frame 102 may include a single pair of support feet 104 extending from the central portion of base frame 102.

In another exemplary embodiment utility jack 100 may include a pair of support arms 106a and 106b. Support arms 106a and 106b may be fixed to base frame 102 via pin assembly 107. Pin assembly 107 may allow support arms 106a and 106b to pivot about the pin assembly 107, while preventing lateral movement of the support arms 106a and 106b with respect to base frame 102. Support arms 106a and 106b may be fixed to base frame 102 via any mechanism known to one skilled in the art that may provide pivotability while inhibiting lateral movement.

Support arms 106a and 106b may extend in a substantially parallel fashion from base frame 102 to upper plate 110. Support arms 106a and 106b may be fastened to a roller assembly 112 having rollers 113 that may engage upper plate 110 via guide rails 111. Guide rails 111 may extend from opposite sides of upper plate 110 and provide a path along which rollers 113 may roll. The engagement of rollers 113 and guide rails 111 can facilitate lateral movement of support arms 106a and 106b with respect to upper plate 110. Support arms 106a and 106b may also engage upper plate 110 via any mechanism that can provide pivotability and lateral movement, known to one skilled in the art.

Similar to support arms 106a and 106b, utility jack 100 may include an additional pair of support arms 108a and 108b. Support arms 108a and 108b may be fixed to upper plate 110 via pin assembly 109. Pin assembly 109 may allow support arms 108a and 108b to pivot about the pin assembly 109, while preventing lateral movement of the support arms 108a and 108b with respect to upper plate 110. Pin assembly 109 may also include a bolt-type fastener, facilitating an adjustable and/or removable connection between pin assembly 109, and subsequently support arms 108a and 108b, and upper plate 110. The bolt-type fastener may be an Allen bolt or any other desired standard or custom bolt. Support arms 108a and 108b may be fixed to upper plate 110 via any mechanism known to one skilled in the art that may provide pivotability while inhibiting lateral movement.

Support arms 108a and 108b may extend in a substantially parallel fashion from upper plate 110 to base frame 102. Support arms 108a and 108b may be fastened to a roller assembly 114 having rollers 115 that may engage base frame 102 via guide rails 103. Guide rails 103 may extend from opposite sides of base frame 102 and provide a path along which rollers 115 may roll. The engagement of rollers 115 and guide rails 103 can facilitate lateral movement of support arms 108a and 108b with respect to base frame 102. Support arms 108a and 108b may also engage base frame 102 via any mechanism that can provide pivotability and lateral movement known to one skilled in the art.

Support arms 106a and 106b may be pivotably fastened to support arms 108a and 108b via pin assembly 116. Pin assembly 116 can provide uniform spacing between support arms 106a and 106b, as well as, between support arms 108a and 108b. Pin assembly 116 may also provide strength and support to the support arms 106a, 106b, 108a and 108b as the upper plate 110 is raised and lowered during use.

Utility jack 100 may also include an engagement bolt 118. Engagement bolt 118 may pass through a hole in pin assembly 109 and a hole in roller assembly 112. Engagement bolt 118 may also include a first end 118a designed for manipulation by a user of the utility jack 100. The first end of the engagement bolt 118a can be shaped for engagement with a standard socket or wrench or can be shaped in any other desired fashion. Engagement bolt 118 may also include a second end 118b that may be threaded and may threadedly engage interior threads of the hole in roller assembly 112.

In an exemplary embodiment, engagement bolt 118 can be rotated by a user. As the engagement bolt 118 is rotated, the second end 118b threaded engagement between the engagement bolt 118 and the roller assembly 112 can force the terminal ends of support arms 106a and 106b to move in a lateral direction toward the terminal ends of support arms 108a and 108b.

Engagement bolt 118 may also include a stopper 120a immediately adjacent to the threaded second end 118b which can be used to prohibit over extension of the support arms 106a and 106b and can act as a safety mechanism securing the position of pin assembly 112 with respect to the engagement bolt 118. Likewise, engagement bolt 118 may include a stopper 120b immediately adjacent to the pin assembly 109 which can be used to prohibit over extension of the support arms 108a and 108b and can act as a safety mechanism securing the position of pin assembly 109 with respect to the engagement bolt 118.

As the terminal ends of the two pairs of support arms 106a, 106b, 108a and 108b converge, upper plate 110 can elevate with respect to base frame 102. Alternatively, if engagement bolt 118 is rotated in an opposite direction the terminal ends of the two pairs of support arms 106a, 106b, 108a and 108b can diverge and upper plate 110 can be lowered with respect to base frame 102.

In another exemplary embodiment upper plate 110 may include a plate pad 110a. The plate pad 110a can be made of various materials, for example rubber, and may facilitate shielding an object from the hard surface of plate 110 while being lifted by utility jack 100. The plate pad 110a may also add slip resistance to the upper plate 110 which may enable increased safety during use. Plate pad 110a may substantially cover the planar portion of the upper plate 110, as shown in FIGS. 1-3, or any other desired portion or location on the upper plate 110.

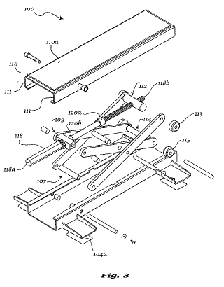

Similarly, in another exemplary embodiment, utility jack 100 may include support feet 104 with feet pads 104a, as shown in FIG. 3. Feet pads 104a can be made of various materials, for example rubber, and may facilitate shielding an object or surface serving as a foundation for utility jack 100 from the hard surface of support feet 104. The feet pads 104a may also add slip resistance to the support feet 104 which may enable increased safety during use. Feet pads 104a can substantially cover the planar portion of the support feet 104, as shown in FIG. 3, or any other desired portion or location on the support feet 104.

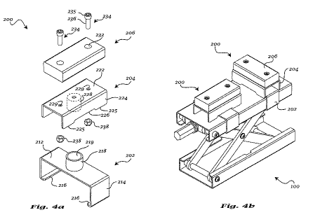

Turning to FIGS. 4a and 4b, in one embodiment, utility jack 100 may include at least one cushion adapter 200. Cushion adapter 200 may facilitate secure support and stabilization of the object to be lifted. Cushion adapter 200 may include a base frame 202, a mounting member 204 and a cushion 206. Base frame 202 may be formed in a substantially rectangular shape or any other desired shape. Base frame 202 may include a horizontal portion 212 and guide rails 214 extending substantially downward from horizontal portion 212. Each guide rail 214 may include a flange 216 extending horizontally therefrom and towards the center of base frame 202. Horizontal portion 212 may have a length greater than the width of top portion 110 of utility jack 100, while guide rails 214 may have a height greater than the height of guide rails 111 of utility jack 100, in order to facilitate slidably coupling base frame 202 with top portion 110. Horizontal portion 212 may also include cylinder 218 substantially cocentered therewith and extending upward therefrom. Cylinder 218 may include therein a cavity 219 substantially concentric thereto.

Mounting member 204 may include a horizontal portion 222 and vertical portions 224 extending downward from horizontal portion 222. Each vertical portion 224 may have a bottom edge 225 and a notch 226 defined in and substantially cocentered with bottom edge 225. Notch 226 may have a length configured to receive horizontal portion 212 of base frame 202 such that bottom edge 225 is in contact with top portion 110 of utility jack 100. Horizontal portion 222 may also include cylinder 228 extending downward therefrom. Cylinder 228 may be configured to slidably engage with cavity 219 of cylinder 218 of base frame 202. Horizontal portion 222 may also include apertures 229 defined therein.

Cushion 206 may be have a substantially cuboid shape or any other desired shape. Cushion 206 may be made of a substantially resilient material, for example but not limited to rubber, and may facilitate shielding an object from horizontal portion 222 of mounting member 204. Cushion 206 may also add slip resistance to horizontal portion 222, which may enable increased safety during use. Cushion 206 may substantially cover horizontal portion 222, or any other desired portion or location on horizontal portion 222. Cushion 206 may include apertures 232 defined therein. Apertures 232 may be configured to receive a bolt 234 such that bolt 234 is recessed within or flush with the top surface of cushion 206. Bolt 234 may have an annular flange 235, a shaft 236, and may threadably couple to nut 238. Annular flange 235 may have a diameter smaller than the diameter of aperture 232 such that annular flange 235 is received within aperture 232. Shaft 236 may have a diameter smaller than the diameter of aperture 229 such that shaft 236 is received within aperture 229.

In operation, the user may slide base frame 202 over top portion 110 of utility jack 100. The user may couple mounting member 204 and cushion 206 by inserting bolt 234 through apertures 232 and apertures 229 and threadably coupling bolt 234 to nut 238. In an alternative embodiment, the user may couple mounting member 204 and cushion 206 by any other coupling means known in the art. The user may then position mounting member 204 over base frame 202 such that cylinder 228 is received within aperture 219 of cylinder 218 and such that bottom edge 225 is in contact with top portion 110. The user may position mounting member 204 such that the longitudinal axis of mounting member 204 is substantially parallel to the longitudinal axis of base frame 202. Alternatively, the user may position mounting member 204 such that the longitudinal axis of mounting member 204 is substantially perpendicular to the longitudinal axis of base frame 202 and such that horizontal portion 212 is received within notch 226.

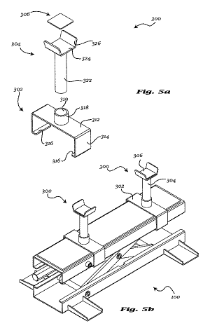

Turning to FIGS. 5a and 5b, in another embodiment, utility jack 100 may include at least one support 300. Support 300 may be configured to receive a frame member of the object to be lifted, wherein the frame member has a substantially rectangular shape. Support 300 may include a base frame 302, a supporting member 304, and a cushion 306. Base frame 302 may be formed in a substantially rectangular shape or any other desired shape. Base frame 302 may include a horizontal portion 312 and guide rails 314 extending substantially downward from horizontal portion 312. Each guide rail 314 may include a flange 316 extending horizontally therefrom and towards the center of base frame 302. Horizontal portion 312 may have a length greater than the width of top portion 110 of utility jack 100, while guide rails 314 may have a height greater than the height of guide rails 111 of utility jack 100, in order to facilitate slidably coupling base frame 302 with top portion 110. Horizontal portion 312 may also include cylinder 318 substantially cocentered therewith and extending upward therefrom. Cylinder 318 may include therein a cavity 319 substantially concentric thereto.

Supporting member 304 may include a shaft 322, a horizontal portion 324 coupled to one end of shaft 322, and flanges 326 coupled to two opposite ends of horizontal portion 324. Each flange 326 may extend substantially upward from horizontal portion 324 such that the angle between horizontal portion 324 and flange 326 is between 90° and 179°. Cushion 306 may be coupled to horizontal portion 324 of supporting member 304. Cushion 306 may be made of a substantially resilient material, for example but not limited to rubber, and may facilitate shielding an object from horizontal portion 324 of supporting member 304. Cushion 306 may also add slip resistance to horizontal portion 324, which may enable increased safety during use. Cushion 306 may substantially cover horizontal portion 324, or any other desired portion or location on horizontal portion 324.

In operation, the user may slide base frame 302 over top portion 110 of utility jack 100, and position supporting member 304 over base frame 302 such that cylinder 322 is received within aperture 319 of cylinder 318. The user may then rotate supporting member 304 such that a desired frame member of the object to be lifted is received between flanges 326, or to any other desired orientation.

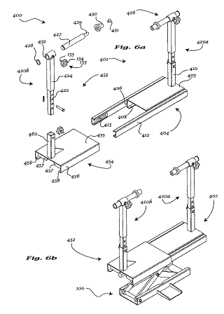

Turning to FIGS. 6a and 6b, in another embodiment, utility jack 100 may include frame support adapter 400. Frame support adapter may be configured to facilitate supporting a desired object via an aperture (not shown) defined on a frame member (not shown) of the desired object (not shown). Frame support adapter 400 may include a first portion 402 and a second portion 452 configured such that first portion 402 may slidably couple with top portion 110 of utility jack 100 and such that second portion 452 may slidably couple with first portion 402.

First portion 402 may include base frame 404, upright member 410, guide rails 412 and support arm 420a. Base frame 404 may be formed in a substantially rectangular shape or any other desired shape. Base frame 404 may include a horizontal portion 405 and guide rails 406 extending substantially downward from horizontal portion 405. Each guide rail 406 may include a flange 408 extending horizontally therefrom and towards the center of base frame 404. Horizontal portion 405 may have a width greater than the width of top portion 110 of utility jack 100, while guide rails 406 may have a height greater than the height of guide rails 111 of utility jack 100, in order to facilitate slidably coupling base frame 404 with top portion 110. Each guide rail 412 may be coupled to a guide rail 406 of base frame 404 and oriented substantially parallel thereto. Each guide rail 412 may be coupled to a guide rail 406 such that a first end of guide rail 412 is substantially flush with a first end of base frame 404, and such that a second end of guide rail 412 extends substantially beyond a second end of base frame 404. Each guide rail 412 may also have a cavity 413 defined therein such that pin assembly 109 may be received within cavity 413. Upright member 410 may be coupled substantially to the first end of base frame 404 such that upright member 410 extends upward therefrom. Upright member 410 may have a cavity defined therein configured to receive support arm 420a. In one embodiment, upright member 410 may have an aperture defined therein.

Second portion 452 may include base frame 454, upright member 460, and support arm 420b. Base frame 454 may be formed in a substantially rectangular shape or any other desired shape. Base frame 454 may include a horizontal portion 455 and guide rails 456 extending substantially downward from horizontal portion 455. Horizontal portion 455 may engage horizontal portion 405 of first portion 402 to facilitate preventing the movement of second portion 452 beyond a predetermined point in relation to first portion 402. Each guide rail 456 may include a flange 458 extending horizontally therefrom and towards the center of base frame 454. Horizontal portion 455 may have a width greater than the width of first portion 402 of frame support adapter 400, while guide rails 456 may have a height greater than the height of guide rails 412 of first portion 402, in order to facilitate slidably coupling base frame 454 with first portion 402. Base frame 454 may also Include support members 457. Upright member 460 may be coupled substantially to a first end of base frame 454 such that upright member 460 extends upward therefrom. Upright member 460 may have a cavity defined therein configured to receive support arm 420b. In one embodiment, upright member 460 may have an aperture defined therein.

Each of support arms 420a and 420b may include an attachment portion 422 having a plurality of apertures defined therein, an upright member 424 and an adjustable shaft 426. Adjustable shaft 426 may include a substantially cylindrical-shaped body 427 that has an end stop 428 coupled at one end of adjustable shaft 426 and an end tip 429 coupled to another end of adjustable shaft 426. In one alternative embodiment, end stop 428 may be, but not limited to, a circular clip. In another alternative embodiment, body 427 may include any shape that enables lifting assembly to function as described herein. In one embodiment, end tip 429 may include a plastic cover 430 coupled thereto using a fastener 431. Plastic cover 430 may have a diameter that facilitates engaging an aperture (not shown) defined on a frame member (not shown) of the desired object to be supported(not shown). As the diameters of such apertures may vary, in one embodiment, the diameter of plastic cover 430 may vary to engage a corresponding aperture. In an alternative embodiment, fastener 431 may be an Allen bolt. Support arms 420a and 420b may also include an adjustment bore 432 defined in an end of support arms 420a and 420b, wherein the end is positioned substantially opposite of the end coupled to attachment portion 422. A locking mechanism 133 may be coupled to the end of support arms 420a and 420b to facilitate locking adjustable shaft 426 thereto in a specific position with respect to support arms 420a and 420b. In one embodiment, locking mechanism 133 may include an adjustment knob 134 and a pin portion 135, wherein pin portion 135 may be coupled to knob 134 and support arms 420a and 420b. In one embodiment, pin portion 135 may be threadably coupled to support arms 420a and 420b such that pin portion 135 extends partially into adjustment bore 432.

Turning to FIGS. 6a and 6b, in one embodiment, adjustment shaft 426 may be inserted within adjustment bore 432 such that end tip 429 faces the opposite lifting arm. End stop 428 may be coupled to adjustment shaft 426 to facilitate preventing adjustment shaft from sliding out of adjustment bore 432.

During operation, plastic cover 430 of support arms 420a and 420b may be inserted into an aperture (not shown) defined on a frame (not shown) of the motorcycle (not shown). Adjustable shaft 426 may be adjusted with respect to support arms 420a and 420b such that plastic cover 430 may be inserted into the motorcycle frame aperture. Once plastic covers 430 are positioned within the motorcycle frame aperture, adjustable shafts 426 may be locked into place using locking mechanism 133. In an alternative embodiment, adjustable shafts 426 and end tips 429 may be coupled to any part of the motorcycle frame known to a person having ordinary skill in the art that enables frame support adapter 400 to function as described herein.

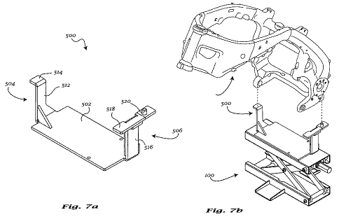

In another embodiment, utility jack 100 may include a frame support adapter 500, as shown in FIGS. 7a and 7b. Frame support adapter 500 may be configured to support particular models of motorcycles or other vehicles (not shown) at specific points defined in the frame thereof. For example, but not limited to, frame support adapter 500 may be configured to support a Yamaha V-Max motorcycle at specific points defined in the frame thereof.

Frame support member 500 may include a base plate 502, a first support member 504 and a second support member 506. Base plate 502 may be formed in a substantially rectangular shape, or any other desired shape. First support member 504 and second support member 506 may be coupled to base plate 502 at substantially opposite ends thereof. First support member 504 may include a vertical member 512 and a horizontal plate 514 coupled substantially to the top end of vertical member 512. Second support member 506 may include a vertical member 516 and a horizontal plate 518 coupled substantially to the top end of vertical member 516. Horizontal plate 518 may have an location pin 520 coupled thereto.

The foregoing description and accompanying drawings illustrate the principles, preferred embodiments and modes of operation of the utility jack. However, the utility jack should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the utility jack as defined by the following claims.

What is claimed is:

1. A utility jack comprising:
a base frame;
an upper plate;
a plurality of support arms engaged with the base frame and the upper plate, wherein the plurality of support arms include first and second support arms adjustably engaged with the upper plate and third and fourth support arms adjustably engaged with the base frame; and
an engagement member coupled to the plurality of support arms, wherein the engagement member manipulates the lateral movement of the plurality of support arms with respect to both the upper plate and the base frame.

2. The utility jack of claim 1, wherein each of the first and second support arms includes a first terminating end attached to a roller.

3. The utility jack of claim 2, wherein the upper plate includes guide rails coupled to opposite sides of the upper plate, wherein the rollers engage the guide rails and the guide rails facilitate lateral movement of the of the first and second support arms with respect to the upper plate.

4. The utility jack of claim 2, wherein each of the first and second support arms includes a second terminating end fixed to the base frame.

5. The utility jack of claim 4, wherein first terminating ends of each of the third and fourth support arms are attached to rollers.

6. The utility jack of claim 5, wherein the base plate includes guide rails coupled to opposite sides of the upper plate, wherein the rollers engage the guide rails and the guide rails facilitate lateral movement of the of the third and fourth support arms with respect to the base frame.

7. The utility jack of claim 6, wherein second terminating ends of each of the third and fourth support arms are fixed to the base frame.

8. The utility jack of claim 1, further comprising:
a plate pad attached to a planar surface of the upper plate.

9. The utility jack of claim 8, wherein the plate pad is made of rubber.

10. The utility jack of claim 1, further comprising:
a plurality of support feet connected to the base frame, wherein each of the support feet extend perpendicularly from the base frame.

11. The utility jack of claim 1, further comprising:
a foot pad attached to at least one of the support feet, wherein the foot pad is attached to the at least one of the support feet at a location that contacts a foundation.

12. The utility jack of claim 11, wherein the foot pad is made of rubber.

13. The utility jack of claim 1, further comprising:
a first pin assembly coupling the first support arm with the second support arm; and wherein the engagement member has a first end that is threaded wherein the first end of the engagement member is threadedly coupled to the pin assembly.

14. The utility jack of claim 13, further comprising:
a second pin assembly coupling the third support arm with the fourth support arm; and wherein the engagement member is coupled to the second pin assembly.

15. The utility jack of claim 14, wherein the second pin assembly is coupled to the upper plate.

16. A cushion attachment for a utility jack, comprising:
a base frame, a mounting member removably coupled to a planar surface of the base frame, and a cushion member removably coupled to a planar surface of the mounting member.

17. The cushion attachment of claim 16, wherein the base frame further comprises guiding members that slidably couple to a utility jack.

18. The cushion attachment of claim 16, wherein the cushion member is made of rubber.

19. A three-wheeled vehicle support attachment for a utility jack, comprising:
a base frame, an upright supporting member removably coupled to the base frame, and a cushion coupled to the supporting member.

20. The three-wheeled vehicle support attachment of claim 19, wherein the base frame further comprises guiding members that slidably couple to a utility jack.

21. The three-wheeled vehicle support attachment of claim 19, wherein the upright supporting member comprises a shaft, a horizontal portion coupled to the shaft, and a plurality of flanges coupled to and extending upward from the horizontal portion.

22. A frame support adapter for a utility jack, comprising:
a first portion, said first portion comprising a base frame, guide rails coupled to the base frame, an upright member coupled to the base frame, and a support arm slidably coupled to the upright member, and;
a second portion slidably coupled to the first portion, said second portion comprising a base frame, an upright member coupled to the base frame, and a support arm slidably coupled to the upright member.

23. The frame support adapter of claim 22, wherein the base frame of the first portion further comprises guiding members that slidably couple to a utility jack.

24. The frame support adapter of claim 22, wherein the support arm further comprises a bore defined in an end of said support arm.

25. The frame support adapter of claim 24, further comprising an adjustment shaft coupled to an end of said lifting arm and positioned within said bore, said adjustment shaft comprising:
a cylindrical body;
an end stop coupled to one end of said cylindrical body; and
an end tip extending away from another end of said cylindrical body.

26. A support platform for a utility jack, comprising:
a base plate;
at least one vertical support member coupled to the base plate and extending vertically therefrom; and
a horizontal support member coupled to the at least one vertical support member.

27. The support platform of claim 26, wherein said horizontal support member is positioned to engage a frame of a motorcycle.

28. A method of elevating an object comprising:
loading an object onto an upper plate supported by a base frame and two pairs of support arms, a first pair and a second pair, each pair of support arms connected at a joint;
actuating an engagement member coupled to both pairs of support arms;
sliding the first pair of support arms in a lateral direction along the upper plate;
sliding the second pair of support arms in a lateral direction along the base frame; and
raising the upper plate by forcing terminating ends of the two pairs of support arms together.

29. The method of claim 28, wherein the actuating of the engagement member includes rotating the engagement member in a first direction.

30. The method of claim 29, further comprising:
actuating the engagement member by rotating the engagement member in a second direction; and
lowering the upper plate.
